(19) United States
(12) Patent Application Publication
(10) Pub. No.: US 2004/0194047 A1
(43) Pub. Date: Sep. 30, 2004

(54) Layout design apparatus

(75) Inventor: Shino Matsubara, Hyogo (JP)

Correspondence Address: BURNS DOANE SWECKER & MATHIS L L P, POST OFFICE BOX 1404, ALEXANDRIA, VA, 22313-1404, US

(73) Assignees: RENESAS TECHNOLOGY CORP; RENESAS LSI DESIGN CORPORATION

(21) Appl. No.: 10/668,089

(22) Filed: Sep. 23, 2003

(30) Foreign Application Priority Data
Mar. 26, 2003 (JP) 2003-85907

(51) Int. Cl. G06F 9/45; G06F 17/50; G06F 9/455

(52) U.S. Cl. 716/11; 716/10; 716/12

(57) ABSTRACT

A layout design apparatus can develop a semiconductor integrated circuit in a shorter period at a lower cost. It includes an initial layout section for performing placement and routing using a netlist of the entire semiconductor integrated circuit such that a first circuit layout whose wiring consists of n (n≧2) wiring layers is formed in a first circuit region, and a second circuit layout, which has wiring consisting of (n−m) (m<n) wiring layers and is connected to the first circuit layout, is formed in a second circuit region; and a layout modifying section for performing placement and routing using a netlist of a third circuit to form a third circuit layout such that its wiring consists of the (n−m) wiring layers constituting the wiring of the second circuit, and for replacing the second circuit layout by the third circuit layout.

### BACKGROUND OF THE INVENTION

1. Field of the Invention

The present invention relates to a layout design apparatus for carrying out layout design of a semiconductor integrated circuit.

2. Description of Related Art

To achieve a layout design of a semiconductor integrated circuit, placement and routing is carried out first by using a netlist of the entire semiconductor integrated circuit. Thus, a layout including n wiring layers is formed, where n is an integer equal to or greater than two.

Subsequently, logic simulation and layout verification of the semiconductor integrated circuit are carried out sequentially using semiconductor layout data.

When a satisfactory logic simulation result and layout verification result are achieved, the layout data of the semiconductor integrated circuit is output, and the layout design is completed. In contrast, if the logic simulation result or layout verification result is unsatisfactory, the placement and routing is performed all over again.

The layout data of the semiconductor integrated circuit is used for fabricating masks thereafter.

To achieve layout design of a new semiconductor integrated circuit by modifying part of the semiconductor integrated circuit that has already undergone the layout design, the layout design is started all over again by creating a netlist of the entire new semiconductor integrated circuit corresponding to the circuit modification.

Recently, a technique has been developed which alters only a layout of a specified wiring layer through the following steps to achieve the layout design of the new semiconductor integrated circuit by modifying part of the semiconductor integrated circuit having undergone the layout design already. These steps include: (a) Receiving a first netlist; (b) Creating a first layout that corresponds to the first netlist, and that includes a component layout and n (n≧2) wiring plane layouts from first to nth planes sequentially piled on the component layout; (c) Receiving a second netlist different from the first netlist; (d) Selecting at least one and at most (n−1) wiring plane layouts from the n wiring plane layouts of the first layout; and (e) Creating a second layout corresponding to a second netlist by modifying the physical structure of at least one wiring plane layout selected, wherein the second netlist consists of the component layout, the unselected wiring plane layouts of the first layout, and the modified wiring plane layouts, (refer to Relevant Reference 1, for example).

Relevant Reference 1: Japanese patent application laid-open No. 2000-82093 (particularly FIG. 1 thereof).

As for the layout design of the new semiconductor integrated circuit by modifying part of the semiconductor integrated circuit having undergone the layout design already, there are following problems. First, the method of performing the layout design all over again has a problem of taking a lot of time for the layout design, thereby lengthening the development period. In addition, since the method must create all the masks for the wiring layers anew, it has a high development cost. On the other hand, the method of modifying the layout of only the specified wiring layers can improve the foregoing problems. However, since it modifies the entire region of the specified wiring layer, it cannot shorten the layout design period sufficiently when only part of the regions is to be modified, thereby lengthening the development period.

In addition, the method does not assume to develop a new semiconductor integrated circuit with a different function by replacing part of the semiconductor integrated circuit by another circuit.

### SUMMARY OF THE INVENTION

The present invention is implemented to solve the foregoing problems. It is therefore an object of the present invention to provide a layout design apparatus enabling the development of a semiconductor integrated circuit in a shorter period at a lower cost.

Another object of the present invention is to provide a layout design apparatus effectively applicable to the development of a new semiconductor integrated circuit with a different function by changing part of the semiconductor integrated circuit to another circuit.

According to an aspect of the present invention, there is provided a layout design apparatus including: an initial layout section for carrying out placement and routing using a netlist of the entire semiconductor integrated circuit such that a layout of the first circuit whose wiring consists of n wiring layers is formed in the first circuit region, where n is an integer equal to or greater than two, and that a layout of the second circuit, which has wiring consisting of (n−m) wiring layers and is connected to the layout of the first circuit, is formed in the second circuit region, where m is a positive integer less than n; and a layout modifying section for carrying out placement and routing using a netlist of a third circuit to form a layout of the third circuit such that wiring of the third circuit consists of the (n−m) wiring layers constituting the wiring of the second circuit, and for replacing the layout of the second circuit formed by the initial layout section by the layout of the third circuit.

Thus, it offers an advantage of being able to develop a semiconductor integrated circuit in a shorter period at a lower cost. In addition, it offers an advantage of being able to effectively develop a new semiconductor integrated circuit with a different function by changing part of the semiconductor integrated circuit into another circuit.

### BRIEF DESCRIPTION OF THE DRAWINGS

FIG. 1 is a block diagram showing a configuration of an embodiment 1 of a layout design apparatus in accordance with the present invention;

FIG. 2 is a flowchart illustrating the operation of an initial layout section of the layout design apparatus as shown in FIG. 1;

FIG. 3 is a flowchart illustrating the operation of a layout modifying section of the layout design apparatus as shown in FIG. 1; and

FIGS. 4A-4E are plan views each showing an example of geometry of a first circuit region and second circuit region.

### DETAILED DESCRIPTION OF THE PREFERRED EMBODIMENT

The invention will now be described with reference to the accompanying drawings.

### EMBODIMENT 1

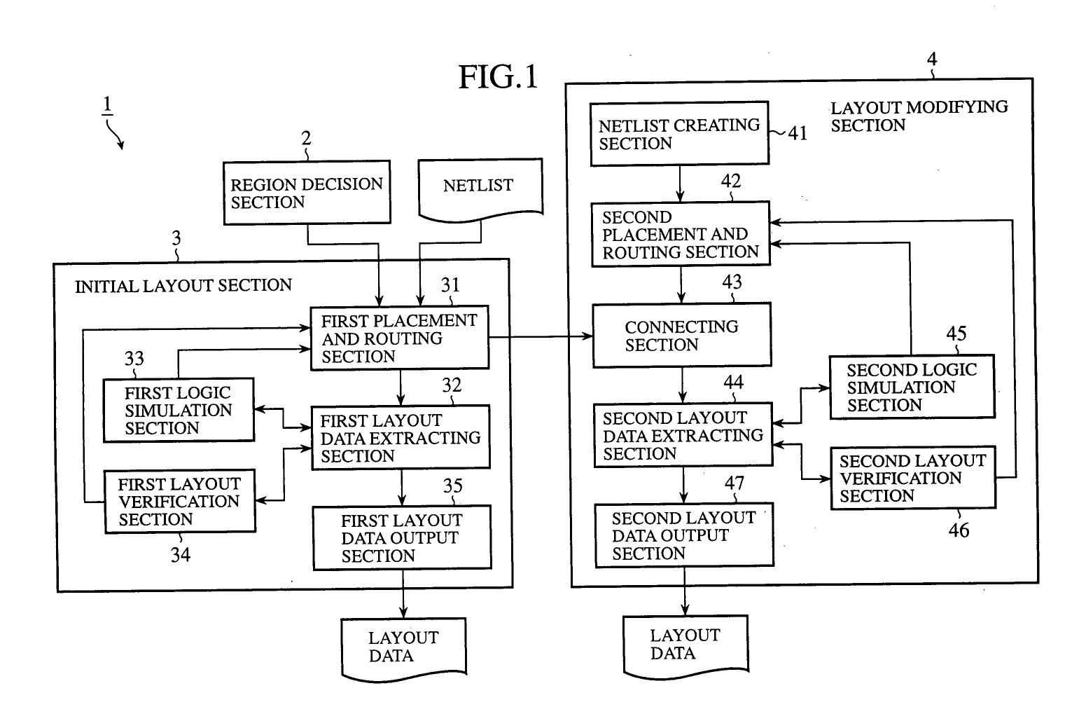

FIG. 1 is a block diagram showing a configuration of an embodiment 1 of a layout design apparatus in accordance with the present invention.

The layout design apparatus 1 comprises a region decision section 2 for determining a first circuit region to be assigned to a first circuit and a second circuit region to be assigned to a second circuit in a semiconductor integrated circuit including the first circuit and second circuit. The first circuit is a circuit not expected to be modified to another circuit, and the second circuit is a circuit expected to be modified to another circuit. The second circuit is a circuit with a specified function represented by a module, for example.

The layout design apparatus 1 further comprises an initial layout section 3 for carrying out placement and routing by using a netlist of the entire semiconductor integrated circuit including the first circuit and second circuit. The initial layout section 3 forms in the first circuit region a layout of the first circuit whose wiring is composed of n wiring layers, where n is an integer equal to or greater than two. The initial layout section 3 further forms in the second circuit region a layout of the second circuit whose wiring is composed of (n−m) wiring layers, where m is an integer less than n. For example, when n=4 and m=2, the wiring of the first circuit is composed of four wiring layers, and the wiring of the second circuit is composed of two wiring layers. The wiring layers here include not only layers on which horizontal wiring is formed, but also layers in which contact holes or via holes are formed. The wiring layers on which the wiring of the second circuit is formed constitute part of the wiring layers on which the wiring of the first circuit is formed. The wiring layers on which the wiring of the second circuit is formed may be the lower, upper or intermediate wiring layers of those constituting the wiring of the first circuit.

The layout design apparatus 1 further comprises a layout modifying section 4 for carrying out placement and routing of a third circuit by using a netlist. The layout modifying section 4 creates a layout of the third circuit such that its wiring is composed of the wiring layers constituting the wiring of the second circuit, and replaces the layout of the second circuit by the layout of the third circuit formed by the initial layout section 3. For example, when n=4 and m=2, the wiring of the third circuit is composed of two wiring layers. For example, if the wiring of the second circuit is composed of the first and second wiring layers, the wiring of the third circuit is also composed of the first and second wiring layers.

The initial layout section 3 includes a first placement and routing section 31 for carrying out placement and routing considering wiring delay by using the netlist of the entire semiconductor integrated circuit including the first circuit and second circuit. The first placement and routing section 31 forms in the first circuit region the layout of the first circuit whose wiring is composed of n wiring layers. It also forms in the second circuit region the layout of the second circuit whose wiring is composed of (n−m) wiring layers. The first placement and routing section 31 further forms wiring connecting the layout of the first circuit and the layout of the second circuit at a boundary between the first circuit region and second circuit region. The netlist of the entire semiconductor integrated circuit includes the netlist of the first circuit, the netlist of the second circuit, and the netlist specifying the connection between the first circuit and second circuit. The first placement and routing section 31 may be configured such that it simultaneously carries out the layout of the first circuit, the layout of the second circuit, and the connection between the layout of the first circuit and the layout of the second circuit. Alternatively, the first placement and routing section 31 may be configured such that it sequentially carries out the layout of the first circuit, the layout of the second circuit, and the connection between the layout of the first circuit and the layout of the second circuit.

The initial layout section 3 further comprises a first layout data extracting section 32 for extracting the layout data of the semiconductor integrated circuit including the first circuit and second circuit; a first logic simulation section 33 for performing a logic simulation of the semiconductor integrated circuit including the first circuit and second circuit using the layout data of the semiconductor integrated circuit; a first layout verification section 34 for carrying out the layout verification of the semiconductor integrated circuit including the first circuit and second circuit using the layout data of the semiconductor integrated circuit; and a first layout data output section 35 for outputting the layout data of the semiconductor integrated circuit including the first circuit and second circuit.

The layout modifying section 4 comprises a netlist creating section 41 for creating a netlist of the third circuit; a second placement and routing section 42 for forming a layout of the third circuit by carrying out placement and routing considering the wiring delay using the netlist of the third circuit in such a manner that the wiring consists of the wiring layers constituting the wiring of the second circuit; and a connecting section 43 for connecting the layout of the third circuit to the layout of the first circuit formed by the first placement and routing section 31 by replacing the layout of the second circuit formed by the first placement and routing section 31 by the layout of the third circuit formed by the second placement and routing section 42. The second placement and routing section 42 forms the layout of the third circuit in such a manner that the size of the layout of the third circuit agrees with the size of the layout of the second circuit. The second placement and routing section 42 further forms the layout of the third circuit in such a manner that the layout of the third circuit is connectable to the layout of the first circuit by using the wiring connecting the layout of the second circuit to the layout of the first circuit. Accordingly, the layout of the third circuit is connectable to the layout of the first circuit by only replacing the layout of the second circuit by the layout of the third circuit.

The layout modifying section 4 further comprises a second layout data extracting section 44 for extracting the layout data of the semiconductor integrated circuit including the first circuit and third circuit; a second logic simulation section 45 for performing a logic simulation of the semiconductor integrated circuit including the first circuit and third circuit using the layout data of the semiconductor integrated circuit including the first circuit and third circuit; a second layout verification section 46 for carrying out the layout verification of the semiconductor integrated circuit including the first circuit and third circuit using the layout data of the semiconductor integrated circuit; and a second layout data output section 47 for outputting the layout data of the semiconductor integrated circuit including the first circuit and third circuit.

Next, the operation of the present embodiment 1 will be described.

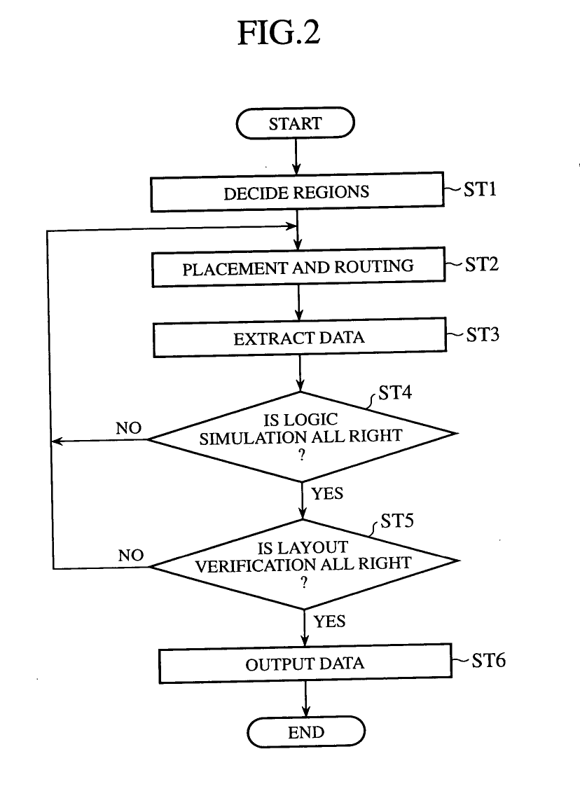

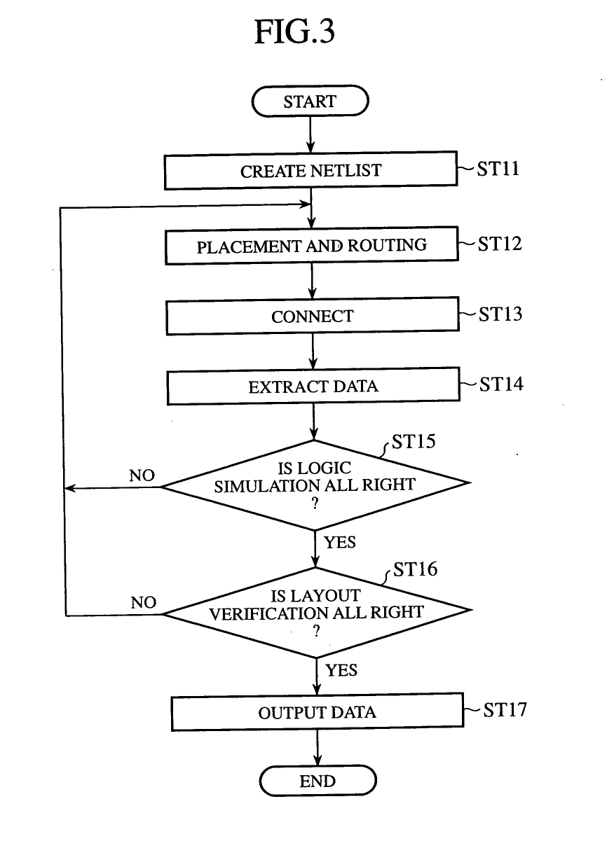

FIG. 2 is a flowchart illustrating the operation of the initial layout section 3 in the layout design apparatus 1 as shown in FIG. 1; and FIG. 3 is a flowchart illustrating the operation of the layout modifying section 4 in the layout design apparatus 1 as shown in FIG. 1.

First, at step ST1, the region decision section 2 determines the first circuit region to be assigned to the first circuit and the second circuit region to be assigned to the second circuit in the semiconductor integrated circuit including the first circuit not intended to be modified to another circuit and the second circuit intended to be modified to another circuit.

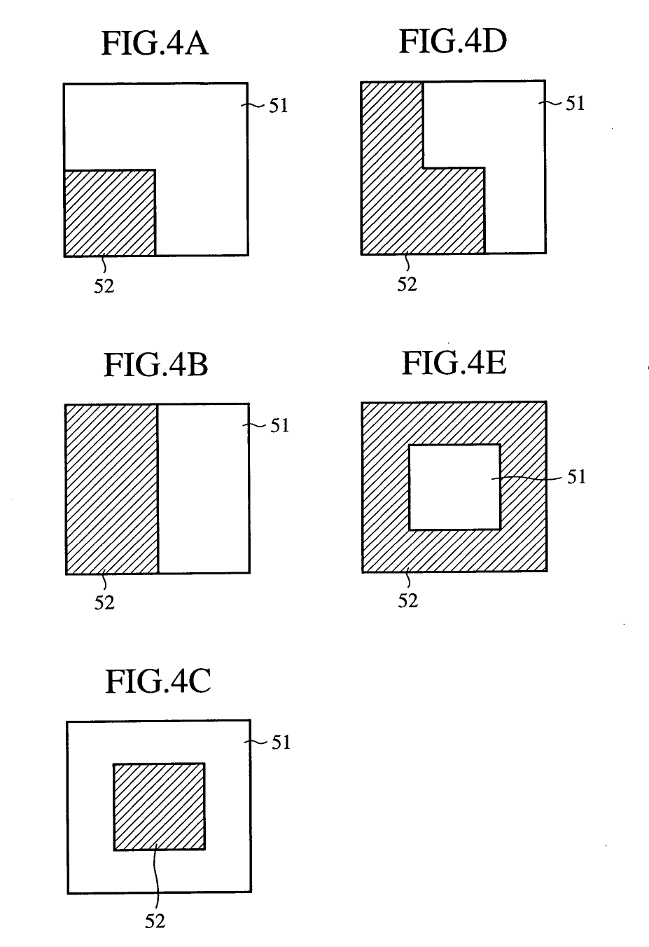

FIGS. 4A-4E are plan views each showing an example of geometry of the first circuit region and second circuit region. In FIGS. 4A-4E, the reference numeral 51 designates the first circuit region, and 52 designates the second circuit region. FIG. 4A shows an example in which the second circuit region 52 is placed at a corner of the layout design region (chip). FIG. 4B shows an example which divides the layout design region (chip) into two rectangular regions, one of which is assigned to the first circuit region 51 and the other of which is assigned to the second circuit region 52. FIG. 4C shows an example which divides the layout design region (chip) into a central region and its surrounding region, in which the central region is assigned to the second circuit region 52 and the surrounding region is assigned to the first circuit region 51. FIG. 4D shows an example which divides the layout design region (chip) into two L-like regions, one of which is assigned to the first circuit region 51 and the other of which is assigned to the second circuit region 52. FIG. 4E show an example which divides the layout design region (chip) into a central region and its surrounding region, and assigns the central region to the first circuit region 51 and the surrounding region to the second circuit region 52.

Subsequently, the first placement and routing section 31 receives the region decision result from the region decision section 2, and a netlist of the entire semiconductor integrated circuit including the first circuit and second circuit from the outside. Then, using the netlist of the entire semiconductor integrated circuit including the first circuit and second circuit, the first placement and routing section 31 carries out placement and routing at step ST2. By the placement and routing, the first placement and routing section 31 forms the layout of the first circuit whose wiring consists of n wiring layers in the first circuit region, forms the layout of the second circuit whose wiring consists of (n−m) wiring layers in the second circuit region, and forms the wiring connecting the layout of the first circuit and the layout of the second circuit at the boundary between the first circuit region and second circuit region.

Subsequently, the first placement and routing section 31 supplies the first layout data extracting section 32 with the placement and routing result, from which the first layout data extracting section 32 extracts the layout data of the semiconductor integrated circuit including the first circuit and second circuit at step ST3.

Subsequently, the first layout data extracting section 32 supplies the layout data of the semiconductor integrated circuit including the first circuit and second circuit to the first logic simulation section 33. Using the layout data of the semiconductor integrated circuit including the first circuit and second circuit, the first logic simulation section 33 carries out the logic simulation of the semiconductor integrated circuit including the first circuit and second circuit at step ST4.

When a satisfactory logic simulation result is obtained, the first logic simulation section 33 supplies the logic simulation result to the first layout data extracting section 32. Then, the first layout data extracting section 32 supplies the first layout verification section 34 with the layout data of the semiconductor integrated circuit including the first circuit and second circuit. Using the layout data of the semiconductor integrated circuit including the first circuit and second circuit, the first layout verification section 34 carries out the layout verification of the semiconductor integrated circuit including the first circuit and second circuit at step ST5. If the logic simulation result is unsatisfactory, the first logic simulation section 33 supplies the logic simulation result to the first placement and routing section 31 so that the first placement and routing section 31 carries out the placement and routing all over again from step ST2.

When a satisfactory layout verification result is obtained, the first layout verification section 34 supplies the layout verification result to the first layout data extracting section 32. The first layout data extracting section 32 supplies the first layout data output section 35 with the layout data of the semiconductor integrated circuit including the first circuit and second circuit. Then, the first layout data output section 35 outputs the layout data of the semiconductor integrated circuit including the first circuit and second circuit to the outside at step ST6. If the layout verification result is unsatisfactory, the first layout verification section 34 supplies the layout verification result to the first placement and routing section 31, which carries out the placement and routing all over again from step ST2.

The layout data of the semiconductor integrated circuit including the first circuit and second circuit is used for producing the masks thereafter.

To perform the layout design of the new semiconductor integrated circuit including the first circuit and third circuit by changing the second circuit to the third circuit, wherein the second circuit is part of the semiconductor integrated circuit including the first circuit and second circuit which has undergone the layout design already, the netlist creating section 41 produces a netlist of the third circuit at step ST11. As an example in which the second circuit is changed to the third circuit, there are cases where the timing of the second circuit is modified (when developing the same production), or where a semiconductor integrated circuit with a different function is developed (when developing a different production).

Subsequently, the netlist creating section 41 supplies the netlist of the third circuit to the second placement and routing section 42. Using the netlist of the third circuit, the second placement and routing section 42 carries out the placement and routing at step ST12. By the placement and routing, the second placement and routing section 42 forms the layout of the third circuit in such a manner that the wiring consists of the wiring layers constituting the wiring of the second circuit.

Subsequently, the second placement and routing section 42 supplies the placement and routing result to the connecting section 43. The connecting section 43 receives the placement and routing result from the first placement and routing section 31, as well. Then, the connecting section 43 replaces the layout of the second circuit formed by the first placement and routing section 31 by the layout of the third circuit formed by the second placement and routing section 42, and connects the layout of the third circuit to the layout of the first circuit formed by the first placement and routing section 31 at step ST13.

Subsequently, the connecting section 43 supplies the connecting result to the second layout data extracting section 44. The second layout data extracting section 44 extracts the layout data of the semiconductor integrated circuit including the first circuit and third circuit at step ST14.

Subsequently, the second layout data extracting section 44 supplies the layout data of the semiconductor integrated circuit including the first circuit and third circuit to the second logic simulation section 45. Using the layout data of the semiconductor integrated circuit including the first circuit and third circuit, the second logic simulation section 45 carries out the logic simulation of the semiconductor integrated circuit including the first circuit and third circuit at step ST15.

When the satisfactory logic simulation result is obtained, the second logic simulation section 45 supplies the logic simulation result to the second layout data extracting section 44. The layout data extracting section 44 supplies the layout data of the semiconductor integrated circuit including the first circuit and third circuit to the second layout verification section 46. Using the layout data of the semiconductor integrated circuit including the first circuit and third circuit, the second layout verification section 46 carries out the layout verification of the semiconductor integrated circuit including the first circuit and third circuit at step ST16. If the logic simulation result is unsatisfactory, the second logic simulation section 45 supplies the logic simulation result to the second placement and routing section 42. The second placement and routing section 42 carries out the placement and routing all over again from step ST12.

When the satisfactory layout verification result is obtained, the second layout verification section 46 supplies the layout verification result to the second layout data extracting section 44. The second layout data extracting section 44 supplies the layout data of the semiconductor integrated circuit including the first circuit and third circuit to the second layout data output section 47. The second layout data output section 47 outputs the layout data of the semiconductor integrated circuit including the first circuit and third circuit to the outside at step ST17. If the layout verification result is unsatisfactory, the second layout verification section 46 supplies the layout verification result to the second placement and routing section 42. The second placement and routing section 42 carries out the placement and routing all over again from step ST12.

The layout data of the semiconductor integrated circuit including the first circuit and third circuit is used for producing masks thereafter.

As described above, the present embodiment 1 of the layout design apparatus 1 carries out the layout design of the semiconductor integrated circuit including the first circuit and second circuit by forming, in different regions, the layout of the first circuit whose wiring consists of the n wiring layers and the layout of the second circuit whose wiring consists of (n−m) wiring layers. Subsequently, when carrying out the layout design of the new semiconductor integrated circuit including the first circuit and third circuit by changing the second circuit to the third circuit, the second circuit being part of the semiconductor integrated circuit including the first circuit and second circuit, which has already undergone the layout design, the layout of the third circuit is carried out in such a manner that its wiring consists of the wiring layers constituting the wiring of the second circuit, thereby replacing the layout of the second circuit by the layout of the third circuit. Thus, modifying only the layout of the (n−m) wiring layers is enough to carry out the layout design of the new semiconductor integrated circuit by modifying part of the semiconductor integrated circuit which has already undergone the layout design. This means that it is necessary to produce only masks for the (n−m) wiring layers, and hence the development cost can be reduced. In addition, only the layout of the circuit located in the specific region is formed anew, which makes it possible to shorten the layout design period, and hence the development period.

Furthermore, the embodiment 1 of the layout design apparatus 1 does not vary the layout of the first circuit. Accordingly, it is effective to develop a new semiconductor integrated circuit by changing part of the semiconductor integrated circuit to another circuit.

Incidentally, the semiconductor integrated circuit subjected to the layout design of the layout design apparatus 1 of the embodiment 1 is such a semiconductor integrated circuit as a gate-array type semiconductor integrated circuit which is fabricated using common masks in the process up to the wiring step, and using individual masks in the process after the wiring step.

In addition, the embodiment 1 can be configured such that it extracts the layout data of the third circuit, and carries out the logic simulation and layout verification of the third circuit by using the layout data of the third circuit.

What is claimed is:

1. A layout design apparatus for carrying out layout design of a semiconductor integrated circuit, said layout design apparatus comprising:
a region decision section for determining, in the semiconductor integrated circuit including a first circuit and a second circuit, a first circuit region to be assigned to the first circuit and a second circuit region to be assigned to the second circuit;
an initial layout section for carrying out placement and routing using a netlist of the entire semiconductor integrated circuit such that a layout of the first circuit whose wiring consists of n wiring layers is formed in the first circuit region, where n is an integer equal to or greater than two, and that a layout of the second circuit, which has wiring consisting of (n−m) wiring layers and is connected to the layout of the first circuit, is formed in the second circuit region, where m is a positive integer less than n; and
a layout modifying section for carrying out placement and routing using a netlist of a third circuit to form a layout of the third circuit such that wiring of the third circuit consists of the (n−m) wiring layers constituting the wiring of the second circuit, and for replacing the layout of the second circuit formed by said initial layout section by the layout of the third circuit.

2. The layout design apparatus according to claim 1, wherein said layout modifying section comprises:
a netlist creating section for creating the netlist of the third circuit;
a placement and routing section for carrying out the placement and routing using the netlist of the third circuit to form the layout of the third circuit such that the wiring of the third circuit consists of the (n−m) wiring layers constituting the wiring of the second circuit; and
a connecting section for replacing the layout of the second circuit formed by said initial layout section by the layout of the third circuit, and for connecting the layout of the third circuit to the layout of the first circuit.

3. The layout design apparatus according to claim 1, wherein the layout of the third circuit is connectable to the layout of the first circuit using the wiring connecting the layout of the second circuit to the layout of the first circuit.
